(19) United States
(12) Patent Application Publication
(10) Pub. No.: US 2008/0292330 A1
(43) Pub. Date: Nov. 27, 2008

(54) IMAGE FORMING APPARATUS

(75) Inventors: Hirotaka KABASHIMA, Tokyo (JP); Hideaki TANAKA, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/098,597

(22) Filed: Apr. 7, 2008

(30) Foreign Application Priority Data
May 24, 2007 (JP) JP2007-137596

(51) Int. Cl. G03G 15/00

(52) U.S. Cl. 399/21

(57) ABSTRACT

In the recovery sequence after detecting recording medium conveyance jam or after detecting empty of recording medium in the sheet feeding tray, by applying a bias having the same polarity as that of the bias of the secondary transfer, remaining toner on the intermediate transfer member is transferred onto the secondary transfer roller side and a part of remaining toner not transferred by slipping through is cleaned by an intermediate member cleaning device disposed between the secondary transfer device and a bending roller being in contact with an outer surface of the intermediate transfer member.

This application is based on Japanese Patent Application No. 2007-137596 filed on May 24, 2007, in Japanese Patent Office, the entire content of which is hereby incorporated by reference.

### BACKGROUND OF THE INVENTION

The present invention relates to an image forming apparatus having an intermediate transfer member.

In the past, an image forming method using an intermediate transfer device having an intermediate transfer member has been commonly known in a field of a copying machine, a printer and a facsimile machine using an electrophotographic method. In the method using the intermediate transfer device, by inserting one more transfer process into a process where a toner image is transferred from an image carrier (so called photoconductive member) to a recording media (so called recording sheet), after the toner image is primarily transferred from the photoconductive member to the intermediate transfer member, a primary transfer image on the intermediate transfer member is secondary transferred onto the recording sheet to obtain a final image. The method using an intermediate transfer device is often utilized as a superimpose transfer method of each color toner image in so called a full color image forming apparatus where a manuscript image is separated into colors and recreated by subtract color mixing with yellow (Y), magenta (M), cyan (C) and black (K).

Concerning intermediated transfer device, in case a failure of conveyance such as a paper jam (also called jam) occurs in mid-course of printing or empty of the recording sheet in the sheet feeding tray in mid-course of consecutive printing, the toner image developed by the primary transfer device may remain on the intermediate transfer member without being transferred onto the recording sheet by the secondary transfer device.

In particular, in case of empty of the recording sheet in the sheet feeding tray in mid-course of consecutive printing, a paper path form sheet feeding rollers of the sheet feeding tray to a secondary transfer position is shorter than a path from a position where the intermediate transfer member first carries out a primary transfer to a position of secondary transfer, therefore in the intermediated transfer member, the image forming operation starts before conveyance of the recording sheet starts. Thus a large amount of toner images which have not been transferred remain on the intermediate transfer member in the meantime, from receiving of a sheet empty detection signal to stopping operation by a control section of the image recording apparatus.

AS for the above problems, countermeasures have been suggested so that toner does not remain on the intermediate transfer member.

For example, U.S. Pat. No. 3,805,782 discloses that toner on the intermediate transfer member is transferred onto a transfer roller (described as “contact transfer member” in the U.S. Pat. No. 3,805,782) and a cleaning device to clean the transfer roller is provided, thereby the remaining toner on the intermediate transfer member is removed. Also, the patent document discloses that to remove the toner adheres on the intermediate transfer member when a jam occur, the power is turned off once and turned on again to make the driving system idle while warming up so that the transfer roller is cleaned while the toner is transferred onto the transfer roller.

The intermediate transfer device has an intermediate transfer member in an endless shape made up of a semi-conductive resin and a plurality of roller members including a tension roller inside the intermediated member, and the intermediate transfer member is trained about the rollers. Further, as FIG. 1 shows, to make the apparatus compact, a bending roller in contact with an outer surface of the intermediate transfer member is provided so that useless spaces can be saved by deforming a part of a loop formed by the rollers.

However, in this method having the bending roller, if toner remains on the intermediate transfer member after transferring, the toner adheres on the bending rollers and begrimes inside the apparatus or the toner comes in contact with the intermediate transfer member and damages a surface of the intermediate transfer member. Further, the damage mark is transferred onto the recording sheet and a problem that the printing quality is deteriorated occurs.

For the above problem, there is a case that in the cleaning method disclosed in the U.S. Pat. No. 3,805,782, transfer to the transfer roller or to the recording sheet cannot be performed completely. In particular, in the method where the bending roller is in contact with the surface of the intermediated transfer member, the bending roller is begrimed with the toner and a preferable printing quality cannot be obtained.

### SUMMARY OF THE INVENTION

An object of the present invention is to provide an image forming apparatus that toner is not remain on the intermediate transfer member thereof, and the bending roller being in contact with the outer surface of the intermediate transfer member is not soiled with toner.

The above object is accomplished by the following structure:

An image forming apparatus, including:

a primary transfer device for developing an electrostatic latent image formed on an image carrier by toner and transferring a visible toner image onto an intermediate transfer member;

a secondary transfer device provided with a secondary transfer roller for transferring the toner image on the intermediate transfer member onto a recording medium and a secondary transfer opposed roller disposed at an opposed position to the secondary transfer roller through the intermediate transfer member;

a secondary transfer bias applying device for applying a bias onto the secondary transfer roller or the secondary transfer opposed roller so as to transfer the toner image onto the recording medium;

a transfer roller cleaning device to clean toner on the secondary transfer roller;

a bending roller being in contact with an outer surface of the intermediate transfer member;

an intermediate transfer member cleaning device disposed between the secondary transfer device and the bending roller to clean toner on the intermediate transfer member;

a control device to control a secondary transfer bias applying device so as to apply the bias having the same polarity as that of the bias of image transfer between the secondary transfer roller and the secondary transfer opposed roller in a recovery sequence executed after detecting an empty of the recording medium in the sheet feeding tray to store the recording medium on the way of successive image forming or after detecting jam of the recording medium on the way of conveyance of the recording medium.

### BRIEF DESCRIPTION OF THE DRAWINGS

FIG. 1 is a schematic diagram of an image forming apparatus related to the present invention.

FIG. 2 is a schematic diagram of a transfer device related to the present invention.

FIG. 3 is a graph showing relations between a secondary transfer current and a toner Q/M when an absolute value of the secondary transfer current is increased.

FIG. 4 is a block diagram of a control system of an image forming apparatus related to an embodiment of the present invention.

FIG. 5 is a flow chart of a portion sequence related to the present embodiment which is conducted by the control device MC.

### DETAILED DESCRIPTION OF THE PREFERRED EMBODIMENT

The present invention will be described based on the embodiment shown by figures without the present embodiment being restricted to the embodiment thereof. Also, the following assertive descriptions of the embodiment of the present invention show a best mode without terminologies and scope of technologies of the present invention being restricted thereto.

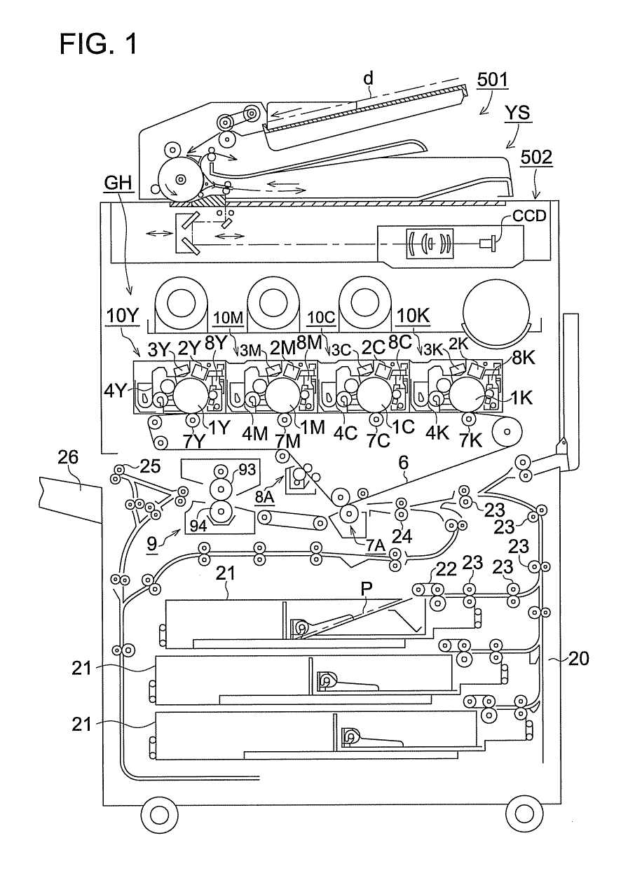

The embodiment related to the image forming apparatus of the present invention will be described with reference to the figures. (Image forming apparatus) FIG. 1 is a schematic diagram of the image forming apparatus related to the present invention. The present image forming apparatus is configured with an image forming apparatus main body GH and an image reading apparatus YS. The image forming apparatus GH is so called a tandem type color image forming apparatus, having a plurality of image forming sections 10Y, 10M, 10C and 10K representing an image forming device, an intermediate transfer member 6, a primary transfer device 7, a secondary transfer device 7A, a sheet feeding device 20, a fixing device 9 and a control device MC.

At an upper portion of the image forming apparatus main body GH, the image reading apparatus YS configured with an automatic document conveyance device 501 and the a document image scanning exposing device 502 is provided. A document d placed on a document table of the automatic document conveyance device 501 is conveyed through a conveyance device and images on a single side or both sides of the document is scanned and exposed through an optical system of the document image scanning exposing device 502 then read in a line image sensor CCD.

A signal created by photoelectric conversion through the line image sensor CCD is sent to the exposing devices 3Y, 3M, 3C and 3K after being processed through analogue processing, A/D conversion, shading correction and image compression.

The image forming section 10Y to form a yellow color image is provided with a charging device 2Y, an exposing device 3Y, a developing device 4Y and a cleaning device 8Y at a periphery of a photoconductive drum 1Y representing an image carrier. The image forming section 10M to form a magenta color image is provided with a charging device 2M, an exposing device 3M, a developing device 4M and a cleaning device 8M at a periphery of a photoconductive drum 1M representing an image carrier. The image forming section 10C to form a cyan color image is provided with a charging device 2C, an exposing device 3C, a developing device 4C and a cleaning device 8C at a periphery of a photoconductive drum 1C representing an image carrier. The image forming section 10B to form a black color image is provided with a charging device 2K, an exposing device 3K, a developing device 4K and a cleaning device 8K at a periphery of a photoconductive drum 1K representing an image carrier. The charging device 2Y and exposing device 3Y, charging device 2M and exposing device 3M, charging device 2c and exposing device 3C, and charging device 2K and exposing device 3K form a latent image forming device.

Meanwhile, the developing device 4Y, 4M, 4C and 4K include two-component developer configured with small particle toner of yellow (Y), magenta (M), cyan (C) and black (K) and a carrier.

The intermediate transfer member 6 is trained about the plurality of the rollers and supported rotatably. The fixing device 9 is a thermal roller fixing device in the embodiment of the present invention. The fixing device J is provided with a fixing roller 93 having a heating device and a pressure roller 94 to press the fixing roller 93 and fixes the toner image on the recording sheet P by heat and pressure in a nip section formed between the fixing roller 93 and the pressure roller 94.

Thereby, each color of image formed by the image forming sections 10Y, 10M, 10C and 10K is successively transferred onto the rotating intermediate member 6 through the primary transfer devices 7Y, 7M, 7C and 7K, to form a toner image where color images are combined.

A recording sheet P stored in a sheet feeding tray 21 representing a recording sheet storing device is separated into one piece through sheet feeding rollers 22 of the sheet feeding device 20, and fed to a resist roller 24 in a stopped state through feeding rollers 23. Here, the recording sheet P stops once then with a timing where a positional relation between the front edge of the sheet and the toner image on the intermediated transfer member 6 is accurately matched, the resist roller 24 starts to rotate to feed the recording sheet P to the secondary transfer device 7A and the color image is transferred onto the recording sheet P (secondary transfer). The recording sheet P on which a color image is transferred is heated and pressed by the fixing device 9 so that the color image on the recording sheet P is fixed thereon. Thereafter, the sheet P is grasped by the sheet ejection rollers 25 and placed on an ejected sheet tray 26 outside the apparatus.

On the other hand, after the color image is transferred onto the recording sheet P by the secondary transfer device 7A, the intermediate transfer member 6, from which the recording sheet P is separated by curvature, is cleaned to remove the remaining toner through the intermediate transfer member cleaning device 8A.

While the above image forming apparatus is to form a color image, it can be an image forming apparatus to form a monochrome image.

While a fixing device 9 utilizes a heat roller fixing device in the embodiment of the present invention, a belt fixing device can be used. (Transfer device)

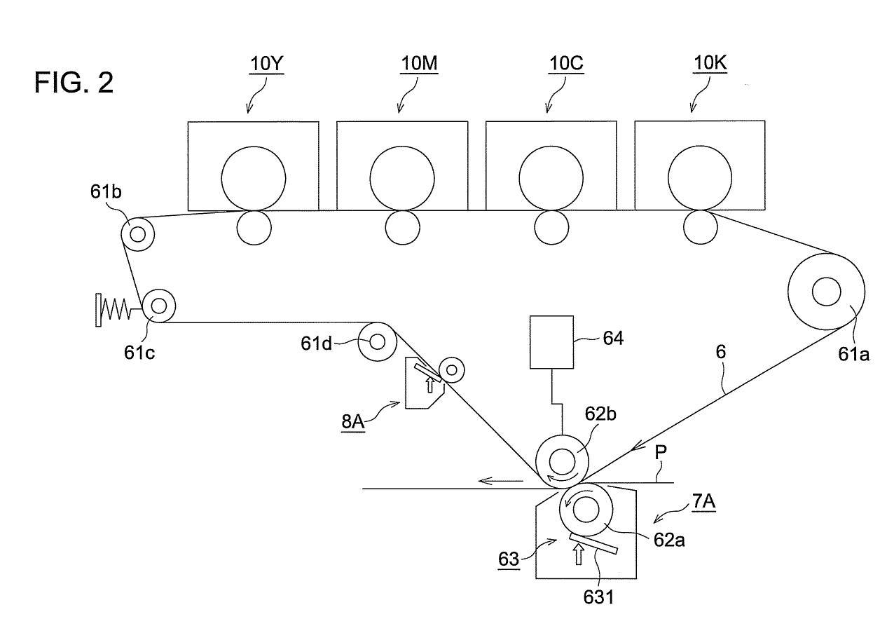

Next, a transfer device will be described in details with reference to FIG. 2. The transfer device in FIG. 2 is configured with a drive roller 61a to wind the intermediate transfer member 6 in an endless shape through an unillustrated drive device, a supporting roller 61b to be rotated along with rotation of the intermediate transfer member 6, and a tension roller to pull the intermediate transfer member 6 with a predetermined force. Further, in FIG. 2, a bending roller 61d in contact with an outside of the intermediate transfer member 6 to be rotated, a secondary transfer roller 62a to configure a secondary transfer device 7A, and a secondary transfer opposed roller 62b disposed on an opposed position to the secondary transfer roller 62 through the intermediated transfer member 6 are shown. A numeral 64 denotes a power source representing a secondary transfer bias applying device to charge the secondary transfer opposed roller 62b. Meanwhile, in the present embodiment, a power source 64 is disposed at secondary transfer opposed roller 62b side, however the power source 64 can be disposed at secondary transfer roller 62a side.

The secondary transfer roller 62a is configured by laminating a flexible semiconductive substance on a metallic base member such as aluminum. As the flexible substance, silicone or urethane rubber is used. Conductive particles are dispersed in the rubber to give conductivity and the electric resistance thereof is adjusted to be 10⁶ to 10¹²Ω. The secondary transfer roller 62b is configured by coating the metallic base member such as aluminum with polyethylene terephthalate and the electric resistance thereof is adjusted to be 10¹²Ω or less. The secondary transfer roller 62a and secondary transfer opposed roller 62b configured as above are arranged so as to be in contact with the intermediate transfer member with pressure in a way along an appropriate nipping width.

Also, a transfer roller cleaning device 63 using an elastic member 631 (so called a cleaning blade 631) is provided so as to clean toner adhering on a periphery of the secondary transfer roller 62a. The rotating roller cleaning device 63 is provided rotatably in a way that an edge surface in a longitudinal direction of the elastic member biases the secondary transfer roller 62a in a counter direction of a rotation direction of the secondary transfer roller 62a.

The intermediate transfer member cleaning device 8A is provided totatably in a way that an edge surface in a longitudinal direction of the elastic member biases the intermediate transfer member 6 in a counter direction of the rotation direction of the intermediate transfer member 6.

For the intermediate transfer member 6, a resin belt member in an endless shape (seamless) having a semi-conductivity where a volume resistance of around 1E+5 to 1E+12Ω·cm and a surface resistance of around 1E+5 to 1E+12Ω is used. As the belt materials, for example, a semi-conductive resin film based member having a thickness of 0.05 to 0.5 mm where a conductive material is dispersed in an engineering plastic such as denatured polyimide, thermoset polyimide, ethylene tetrafluoroethylene copolymer, polyvinylidene-fluoride, nylon alloy is used. Other than the above, a semi-conductive rubber belt having thickness of 0.5 to 2.0 mm where a conductive material is dispersed in silicone rubber or urethane rubber can be used.

The secondary transfer opposed roller 62b is connected with a power source 64 to apply a secondary transfer bias, and in case the toner used in the present embodiment is negative, negative charge which is the same polarity as the toner is applied. On the other hand, the secondary transfer roller 62a is connected to ground. Thereby, when the recording sheet P passes the secondary transfer device 7A, the toner having negative polarity is repelled by negative charge and transferred onto the recording sheet P. Meanwhile, if the power source 64 is connected with the secondary transfer roller 62a side, by giving an opposite polarity of charge of the toner (this case positive) toner of negative polarity is attracted to the positive side and transferred on the recording sheet P located therebetween.

Next, When a jam occurs during conveyance of the recording sheet P or the recording sheet P in the sheet feeding tray 21 runs out in mid-course of successive printing, the image forming apparatus is stopped by a control device MC (unillustrated) incorporated in the apparatus. In the image forming apparatus in halting state, toner images developed by the primary transfer device are not developed by the secondary transfer device 7A, and a large amount of toner remains on the intermediate transfer member 6.

In general, when a jam occurs or when the recording sheet P in the sheet feeding tray 21 runs out, a user opens a front door of the apparatus and removed a jamming sheet for recovery, or withdraws the sheet feeding tray to fill the recording sheet P and closes the door. For this occasion, a sub-switch such as a door switch is provided for the purpose of safety when the front door is open and closed. The control device MC recognizes that the recovery process is completed by a signal when the sub switch is turned on (when the door is closed) and checks the initial setting items of the apparatus. The initial setting items include an item to operate the drive system which rotates the photoconductive drum and the intermediate transfer member and an item to turn on the fixing heater until the fixing temperature reaches to a predetermined temperature.

Herein, the recovery sequence is defined as a successive operation from turning on the sub-switch to completion of checking of the initial setting items. Within the sequence, an operation to rotate the intermediated transfer member for cleaning is included.

In the present embodiment, to remove the remaining toner on the intermediate transfer member 6, the intermediate transfer member 6 rotates during the recovery sequence, and a secondary transfer bias current is applied onto the secondary transfer opposed rollers 62b from the power source 64 so that the rollers 62b are charged in the same polarity as that of the charge for image transfer onto the recording sheet P. The absolute value of the secondary bias current is greater than the absolute value of the current for transferring the image onto the recording sheet P. Namely, the charge amount (Q/M) of toner on the secondary transfer roller 62a is reduced so that cleaning by the cleaning blade 631 can be carried out readily.

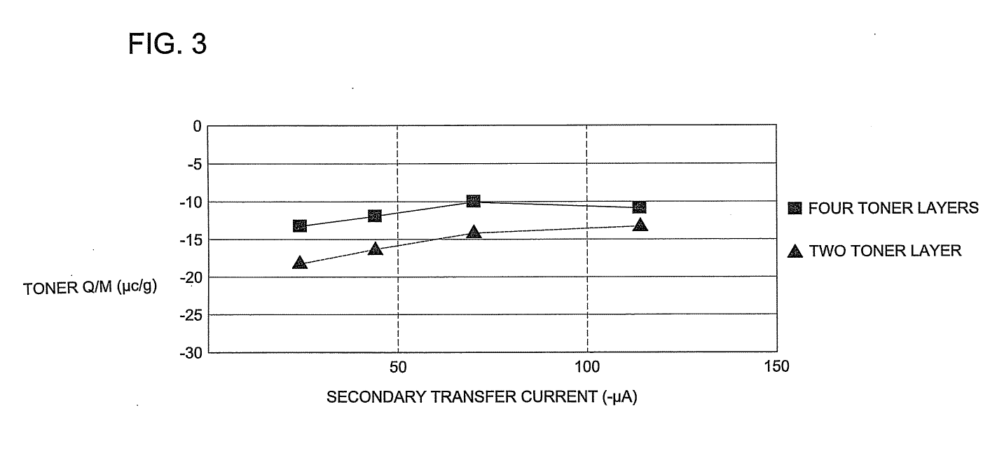

FIG. 3 shows a relation between the secondary transfer bias (herein described in amperage value) and the toner Q/M when the absolute value of the secondary transfer bias is increased. In FIG. 3, when the secondary transfer bias current is changed from −20 μA to −120 μA (increased in the absolute value) toner Q/M is changed from −15 μC/g to −10 μ/g (decreased in the absolute value). As the toner Q/M approaches to zero, an electrostatic absorption force is reduced and cleaning can be carried out readily. Also, in FIG. 3, the toner Q/M of four layers (four colors) is smaller than that of two layers (two colors), namely four colors is easier to be cleaned.

The toner adhered on the secondary transfer roller 62a is cleaned by the cleaning blade 631. The secondary transfer roller 62a rotates a plurality of times while the intermediate transfer member 6 rotates once, since the secondary transfer roller 62a has a shorter circumferential length than that of the intermediate transfer member 6. Even if the intermediated transfer member 6 does not complete one rotation, all the toner adhering on the secondary transfer roller 62a is cleaned through a plurality of times of rotations.

On the other hand, the toner remaining on the intermediate transfer member 6 is cleaned by an intermediate cleaning member 8A located between the secondary transfer device and the bending roller so as to prevent the bending roller 61d disposed at the downstream side thereof from being begrimed by the toner.

Further, to relief a load of the cleaning belt, it is preferred to use a cleaning brush (unillustrated) as the intermediate member cleaning device 8A, in combination.

Also, in the recovery sequence, the exposing devices 3Y, 3M, 3C and 3K are stopped so as not to create a new image on the photoconductive drum 1 and a bias voltage having an opposite polarity to that of primary transfer is applied to the transfer roller of the primary transfer device 7 so as to prevent transfer to the intermediate transfer member 6.

### (Control Device)

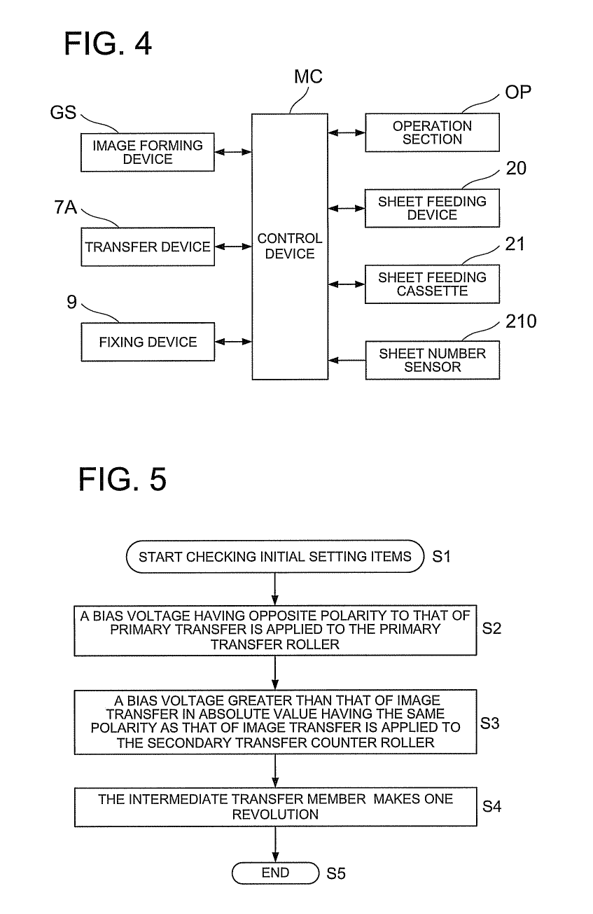

FIG. 4 is a block diagram of a control system of the image forming apparatus related to the embodiment of the present invention. The control device configured with the micro computer controls overall. A symbol GS denotes a image forming device showing the image forming sections 10Y, 10M, 10C, 10K and the intermediate transfer member overall, a symbol 7A denotes a transfer device, a numeral 9 denotes a fixing device, a symbol OP denotes an operation section, a numeral 20 denotes a sheet feeding device and a numeral 21 denotes a sheet feeding cassette. A numeral 210 denotes a sheet number sensor to detect if the recording sheet P in the sheet feeding cassette is one or more than two pieces.

The control device MC communicates signals among the image forming section GS, the transfer device 7A, the fixing device 9, the operation section OP, the sheet feeding device 20 and the sheet feeding cassette 21 and controls to operates them. When a sheet number sensor 210 detects that the number of the remaining sheets P is one, image forming in the image forming device GS is controlled to be stopped.

Next, a part related to the present embodiment executed by the control device MC after recovering process and the sub-switch is turned on will be described with reference to a flow chart of FIG. 5.

Step S1: Start checking initial setting items.
Step S2: A bias having an opposite polarity to that of the primary transfer is applied to the primary transfer roller 62b.
Step S3: A bias voltage greater than that of image transfer in absolute value having the same polarity as that of image transfer is applied to the secondary transfer opposed roller 62b.
Step S4: The intermediate transfer member 6 makes one revolution.

### Step S5: End

### Embodiment

Next, table 1 shows a secondary transfer current value at a ordinary image transfer, a secondary transfer current value in the recovery sequence, number of prints when the intermediate transfer member cleaning device becomes out of order and number of prints when the bending roller is begrimed.

TABLE 1

| | Secondary transfer | | | |
|---|---|---|---|---|
| | current | | | |
| | | At holt | Intermediate | |
| | | without | transfer | Adhesion of |
| | | sheet/At | member | toner on the |
| | At image | recovery due | cleaning | bending |
| | transfer | to jam | failure | roller |
| Embodiment 1 | −50 μA | −120 μA | No failure | No failure |
| | | | occurred up | occurred up |
| | | | to 500kp | to 500kp |
| Embodiment 2 | −50 μA | −100 μA | No failure | No failure |
| | | | occurred up | occurred up |
| | | | to 500kp | to 500kp |
| Embodiment 3 | −50 μA | −60 μA | No failure | No failure |
| | | | occurred up | occurred up |
| | | | to 500kp | to 500kp |
| Embodiment 4 | −50 μA | −50 μA | Failure | No failure |
| | | | occurred at | occurred up |
| | | | 420kp | to 500kp |
| Embodiment 5 | −50 μA | −40 μA | Failure | No failure |
| | | | occurred at | occurred up |
| | | | 400kp | to 500kp |

### Common Condition

Process speed: 220 mm/sec.

### Intermediate Transfer Member Cleaning Conditions

Blade contact pressure: 18 N/m

Brush roller: Nylon 2d (denier), 240K strands

### Secondary Transfer Roller Cleaning Conditions

Blade contact pressure: 20 N/m

Brush roller: Polyester 6d (denier), 120K strands

Lubricant bias pressure: 490 mN

Toner average particle diameter: 6.5 μm

### Test Method

Halts by empty of sheet are inserted in every 5000 prints. 500,000 prints are carried out in a full color mode (amount of toner on the intermediate transfer member: 15 g/m²).

In the table 1, the polarities of the transfer current applied to the secondary transfer roller at image transfer and in the recovering sequence are the same and if the secondary transfer current having a greater absolute value than that of the transfer current at image transfer to the secondary transfer roller is applied, a status of embodiment 4 is improved to be statuses of embodiments 1 to 3 where adhesion of toner onto the intermediate transfer member cleaning device and the bending roller can be prevented.

As mentioned above, the intermediate transfer member cleaning device 8A and the transfer roller cleaning device 63 are provided, and the second transfer bias having the same polarity as that of the second transfer is applied in the recovery sequence after detecting recording medium conveyance jam or after detecting empty of the sheet in the sheet feeding tray. Further, when this occurs, by making the absolute value of the second transfer bias greater than that of image transfer, only small amount of remaining toner remains on the intermediate transfer member and, furthermore, the smaller amount of remaining toner can be cleaned by the intermediate transfer member cleaning device 8A. As a result, even if the bending roller in contact with the outer surface of the intermediate transfer member is provided, grime caused by adhesion or fusion bonding of toner onto the roller can be prevented.

What is claimed is:

1. An image forming apparatus, comprising:
a primary transfer device for transferring a toner image, which is visualized by developing an electrostatic latent image formed on an image carrier, onto an intermediate transfer member;
a secondary transfer device provided with a secondary transfer roller for transferring the toner image on the intermediate transfer member onto a recording medium and a secondary transfer opposed roller disposed at an opposed position to the secondary transfer roller through the intermediate transfer member;
a secondary transfer bias applying device for applying a bias onto the secondary transfer roller or the secondary transfer opposed roller so as to transfer the toner image onto the recording medium;
a transfer roller cleaning device to clean toner on the secondary transfer roller;
a bending roller being in contact with an outer surface of the intermediate transfer member;
an intermediate transfer member cleaning device disposed between the secondary transfer device and the bending roller to clean toner on the intermediate transfer member;
a control device to control the secondary transfer bias applying device so as to apply the bias having the same polarity as that of the bias of image transfer between the secondary transfer roller and the secondary transfer opposed roller in a recovery sequence executed after detecting an empty of the recording medium in a sheet feeding tray to store the recording medium on the way of successive image forming or after detecting jam of the recording medium on the way of conveyance of the recording medium.

2. The image forming apparatus of claim 1, wherein the control device controls the secondary transfer bias applying device so that, in the absolute value, the bias applied in the recovery sequence is greater than the secondary transfer bias that the secondary transfer device transfers the image onto the recording medium.

3. The image forming apparatus of claim 1, wherein the bending roller is disposed at a downstream side of the secondary transfer roller in respect to the intermediate transfer member.
